(19) United States
(12) Patent Application Publication
(10) Pub. No.: US 2007/0143742 A1
(43) Pub. Date: Jun. 21, 2007

(54) SYMBOLIC MODEL CHECKING OF CONCURRENT PROGRAMS USING PARTIAL ORDERS AND ON-THE-FLY TRANSACTIONS

(75) Inventors: Vineet KAHLON, Plainsboro, NJ (US); Aarti GUPTA, PRINCETON, NJ (US); Nishant SINHA, PITTSBURGH, PA (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 11/611,847

(22) Filed: Dec. 15, 2006

Related U.S. Application Data
(60) Provisional application No. 60/743,055, filed on Dec. 20, 2005.

(51) Int. Cl. G06F 9/44

(52) U.S. Cl. 717/124

(57) ABSTRACT

A set of techniques for analyzing concurrent programs that combines the power of symbolic model checking to explore large state spaces, and partial order and transaction-based reduction techniques to manage the size of explored state space.

### CROSS REFERENCE TO RELATED APPLICATIONS

This application claims the benefit of U.S. Provisional Application No. 60/743,055 filed 20 Dec. 2005 the entire contents of which are incorporated by reference as if set forth at length herein.

### FIELD OF THE INVENTION

This invention relates generally to the field of computer software and in particular it pertains to a software verification methodology for concurrent programs.

### BACKGROUND OF THE INVENTION

The widespread use of concurrent software in modem computing systems necessitates the development of effective verification methodologies for multi-threaded programs. As can be appreciated however, subtle interactions between threads makes multi-threaded software behaviorally complex and particularly hard to analyze and—as a result—formal methodologies are employed for their debugging. Not surprisingly, model checking—both symbolic and explicit state—for the verification of concurrent software has been an active area of research.

Explicit state model checkers, such as Verisoft (See e.g., P. Godefroid, “Model Checking For Programming Languages Using Verisoft”, POPL '97, pp. 174-186, 1997) explore an enumeration of the states and transitions of the concurrent program under study. Additional techniques such as state hashing for compaction of state representations, and partial order methods are typically used to avoid exploring all of the interleavings and transitions of constituent threads. And while these techniques have proven to be effective at state space reduction, they do not address scalability problems that arise due to state explosion when model checking large-scale concurrent programs.

Symbolic model checkers—on the other hand—avoid an explicit enumeration of the state space by using symbolic representations of sets and states and transitions. One successful approach in this regard was the use of Binary Decision Diagrams (BDDs) to succinctly represent large state spaces for the purpose of model checking (See, e.g., K. L. McMillan, “Symbolic Model Checking: An Approach To The State Explosion Problem, Kluwer Academic Publishers, 1993). Subsequently, Boolean Satisfiability (SAT)-based techniques have become popular both for finding software bugs using SAT-based bounded model checking (BCC) and generating proofs via SAT-based unbounded model checking (UMC).

Given their importance, techniques that improved upon or extended the applicability of model checking would represent a significant advance in the art.

### SUMMARY OF THE INVENTION

We have developed, in accordance with the principles of the invention, methodology which advantageously leverages the synergy which results from combining partial order techniques to reduce the state space of a system to be explored with the power of symbolic model checking techniques to explore large state spaces. In sharp contrast to existing methods that employ BDDs which encode the entire state of a given concurrent program thereby producing a state space explosion—the method of the present invention provides the freedom to use any technique of choice—either SAT or BDD-based. As those skilled in the art will readily appreciate, such an approach is much more scalable than the prior art approach(es) which required the use of BDDs.

According to an aspect of the present invention, a given concurrent program is translated into a circuit-based (finite-state) model. Accordingly, a finite model for each individual thread is obtained wherein each variable of the thread is represented in terms of a vector of binary-valued latches and a Boolean next-state function (or relation) for each latch. Next—using a scheduler—the circuits for the individual threads are composed into one single circuit for the entire concurrent program. Verification is then performed on this circuit and partial order techniques are incorporated into the framework by statically augmenting the circuit-based Boolean encoding of the concurrent program with additional constraints. According to an aspect of the present invention—these constraints restrict the transitions explored from each global state to a minimal conditional stubborn set of that state.

Viewed from yet another aspect, the present invention provides an improved method for identifying transactions on-the-fly that is based upon analyzing patterns of lock acquisitions. In sharp contrast, prior art methods employ lockset based analysis. As those skilled in the art will appreciate, lockset based methods for state space reduction exploit the ability of locks to enforce mutually exclusive access to regions of code encapsulated between locking and unlocking operations. Such prior art lockset methods rely on the assumption that a concurrent program follows a lock discipline in accessing shared variables, i.e., that all accesses to a shared variable sh are protected by the same lock Iₛₕ.

According to an aspect of the present invention however, patterns of lock acquisitions are analyzed—rather than locksets—thereby producing a demonstrably more comprehensive result. In addition, a method according to the present invention does not require nor rely on a concurrent program exhibiting lock discipline. Consequently, the present invention permits the use of lock-based reductions for a broader class of concurrent programs.

Viewed from yet another aspect, the present invention permits the transparent incorporation of lock-pattern based transactions into partial order reductions by improved conditional dependency detection via the addition of extra constraints—which are not incorporated into the transition relation a-priori but dynamically while unrolling the executions of the threads. As a result, increased granularity of transitions due to transactions can be captured as a reduction in the sizes of conditional stubborn sets of states.

Finally, the present invention provides a new approach for model checking concurrent programs that combines the power of symbolic techniques with partial order reduction and on-the-fly transactions while—at the same time—retaining the flexibility to employ a broad arsenal of model checking techniques—both SAT and BDD-based—to check not just reachability but richer classes of linear temporal problems as well.

### BRIEF DESCRIPTION OF THE DRAWING

A more complete understanding of the present invention may be realized by reference to the accompanying drawing in which:

FIG. 1 is a program segment showing threads T₁ FIG. 1(a) and T₂ FIG. 1(b) with unprotected access to x;

FIG. 2 is a program segment showing threads T₁ FIG. 1(a) and T₂ FIG. 1(b)with unprotected access to x illustrating the identification of transactions in the absence of lock discipline; and

FIG. 3 is a block diagram depicting an overview of the present invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

By way of additional theoretical background, we consider concurrent systems having a finite number of processes or threads where each thread is a deterministic sequential program written in a language such as C. As is known, threads may interact with each other using communication/synchronization objects like shared variables, locks and semiphores.

Formally, we define a concurrent program CP as a tuple (T,V,R,s₀) where T={T₁, . . . , Tₙ} denotes a finite set of threads, V={v₁, . . . , vₘ} a finite set of shared variables and synchronization objects with vᵢ taking on values from the set Vᵢ, R the transition relation and s₀, the initial state of CP. Each thread Tᵢ is represented by a control flow graph of the sequential program it executes, and is denoted by the pair (Cᵢ,R), where Cᵢ denotes the set of control locations of Tᵢ and Rᵢ its transition relation.

A global state s of CP is a tuple:
(s[1], . . . s[n],v[1], . . . v[m])εS=C₁× . . . ×Cₙ×V₁× . . . ×Vₘ;
where s[i] represents the current control location of thread Tᵢ and v [j] the current value of variable Vⱼ. The global state transition diagram of CP is defined to be the standard interleaved composition of the transition diagrams of the individual threads. Thus each global transition of CP results by firing a local transition of the form (aₛ,g,u,bᵢ) where aᵢ and bᵢ are control location in some thread Tᵢ=(Cᵢ,Rᵢ) with (aᵢ,bᵢ) E R.; gi is a guard which is a Boolean-valued expression on the values of local variables of Tᵢ and global variables in V; and u is a function that encodes how the value of each global variable and each local variable of Tᵢ is updated.

A transition t=(aᵢ,g,u,bᵢ) of thread Tᵢ is enabled in state s iff s[i]=aᵢ but g need not be true in s, then we simply say that t is scheduled in s. We write

$$s {\to }^{t} {s}^{′}$$

to mean that the execution of t leads from states s to s′. Given a transition tεT, we use proc(t) to denote the process executing t. Finally, we note that each concurrent program CP with a global state space S defines the global transition system A_{g}=(S,Δ,s₀), where Δ⊂S×S is the transition relation defined by

$$( s , {s}^{′} ) ∈ Δ iff ∃ t ∈ T \text{:} s {\to }^{t} {s}^{′} ;$$

and s₀ is the initial state of CP.
Lock Synchronization Based Reductions

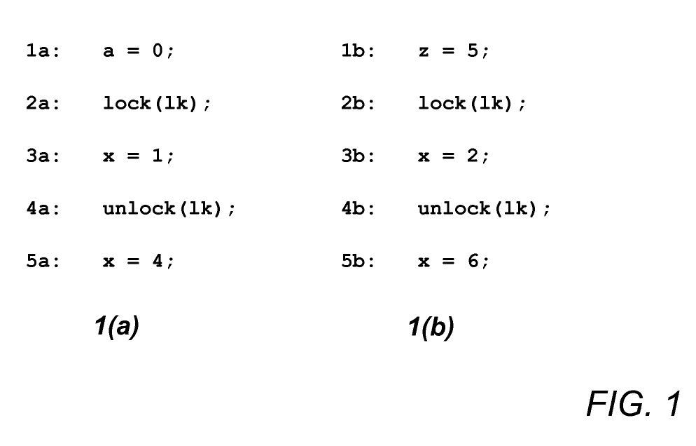

We begin our discussion through the use of motivating examples. Consider a concurrent program CP shown as a program segment in FIG. 1. With reference to that FIG. 1, we see two threads T₁ and T₂ shown in FIG. 1(a) and FIG. 1(b), respectively. We note that x, which is the only variable shared among the two threads is unprotected at control location 5b and protected by lock lk at all other locations. Since x is unprotected at all locations where it is accessed, it does not satisfy the lock discipline mentioned earlier and (See, e.g., “Model Checking Multi-Threaded Distributed JAVA Programs', authored by Scott D. Stoller and which appeared in International Journal On Software Tools For Technology Transfer, 4(1), pp. 71-91, October 2002) which will therefore force a context switch before locations 3a and 3b.

Consider a global state s of CP with threads T₁ and T₂ at control locations 3a and 3b respectively. A key observation is that starting at global state s of CP, 3a does not interfere with 3b and 5b even though 5b is unprotected. This is due to the fact that for T₂ to execute 3b it has to acquire lk currently held by T₁. But in order for T₁ to release lk, it must first execute 3a.

Thus starting at s, CP is forced to execute 3a before 3b. As a result no context switch is required before 3a. However, in the global state s′ with T₁ and T₂ at control locations 3a and 5b respectively, the transitions 3a and 5b do interfere with each other thereby forcing a context switch before 3a. As can be appreciated by those skilled in the art, even though shared variables need not follow a locking discipline globally, there are still identifiable portion of the state space where locking discipline is followed. Thus a context driven analysis allows us to define transactions locally—on-the-fly—where prior art methods—because of their reliance on global analysis—fail to do so.

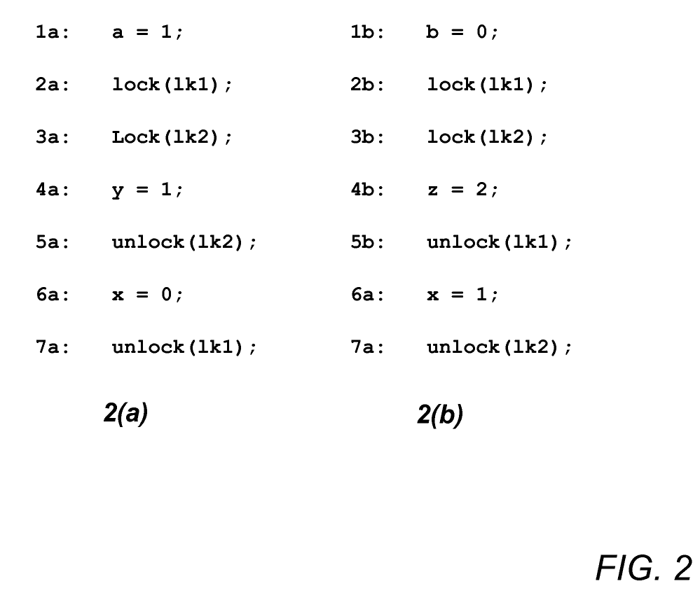

Taking this further, we can now show that transactions may be identified even in the absence of lock discipline—local or global. With reference now to FIG. 2, there is shown program segment threads T₁ and T₂ in FIG. 2(a) and FIG. 2(b) respectively each having unprotected access to x. We let CP be a concurrent program comprising these two threads T₁ and T₂ both sharing variable x as shown.

Consider a global state s of CP with threads T₁ and T₂ in control locations 6a and 1b, respectively. Observe that starting at s, the transitions at control locations 6a and 6b cannot interfere with each other even though they access the same shared variable x This is because in order for thread T₂ to reach location 6b from location 1b it has to traverse the local path 1b, 2b, 3b, 4b, 5b, along which it has to acquire (and release) lock lk1. currently held by T₁. In order for that to happen, T₁ must release lk1 for which it must execute transition 6a. As a result, transition 6a is forced to be executed before transition 6b. Thus no context switch is required before location 6a.

One key observation to be made here is that even though disjoint sets of locks were held at locations 6a and 6b, it was the set of locks that needed to be acquired by T₂ in order to transit from 1b to 6b (even though some of these locks were released before reaching 6b) that prevented 6a and 6b from interfering with each other. A traditional, prior-art, lockset-based analysis such as presented in [Sto02,FQ03] would treat 6a and 6b as conflicting transitions (as x does not follow locking discipline) and force a context switch before these locations.

Consequently, those skilled in the art will recognize that a conflict analysis based on lock acquisition patterns according to the present invention is more refined than one based on locksets.

Transactions VIA Persistent Sets

We may now show how to integrate lock-pattern based on-the-fly transactions with partial order reduction in a transparent fashion by capturing the increased granularity of transitions due to transactions as a reduction in the sizes of the conditional stubborn sets of states. This is accomplished by ensuring that if in a global state s, a thread Tᵢ is executing a transaction then, in the persistent set of s, we include only one transition, viz., the transition of Tᵢ that fires next along the transaction being executed. This ensures that once the first transition of a transaction is executed, by a thread Tᵢ then no other process can be scheduled unless all transitions of the transaction finish firing.

State space reduction using partial order techniques is obtained by exploring from each individual state only those transitions that belong to a persistent set of that individual state instead of all the enabled transitions. Although there are many ways to compute persistent sets, a method of computing conditional stubborn sets usually generates those with small cardinality. For our purposes herein, we use standard terminology from the theory of partial order reductions and the algorithm for computing conditional stubborn sets (See, e.g., P. Godenfroid, “Partial Order Methods For The Verification of Concurrent Programs: An Approach To The State Explosion Problem”, LNCS 1032, Springer-Verlag, 1996) which we denote by Algo₁.

We begin by recalling the following definition:

Might-be-first-to-interfere: Let op and op′ be two operations on the same object O and s be a reachable state. The relation op [symbol] ₛ op′ holds if there exists a sequence

$$s = {s}_{1} {\to }^{{t}_{1}} {s}_{2} {\to }^{{t}_{2}} … {\to }^{{t}_{n}} {s}_{n + 1}$$

of transitions in A_{G} such that ∀1≦i<n: ∀op″ on O used by tᵢ: op and op′ are dependent in sₙ.

For each local transition

$$a {\to }^{g} b$$

of a thread, we let used(t) denote the set of operations on variables and synchronization objects executed during the execution of t. A conditional stubborn set of state s of A_{G} can then be calculated as follows:
1. Initialize Tₛ={t}, where t is some enabled transition in s.
2. For each

$$t = a {\to }^{g} b ∈ {T}_{s}$$

(a) If t is disabled in s,
i. If Tⱼ=Proc(t) and s[j]≠a then add to Tₛ all transitions t′ of Tⱼ of the form

$$c {\to }^{{g}^{′}} a$$
, or
ii. Choose a condition cⱼ in the guard g of t that evaluates to false in s; then, for all operations op used by t to evaluate cⱼ, add to Tₛ all transitions t′ such that ∃op′ ε used (t′): op [symbol] ₛ op′

(b) If t is enabled in s add to Tₛ all transitions t′ such that proc (t)≠proc(t′) and ∃op ε used (t), ∃op′ ε used (t′): op [symbol] ₛ op′

3 Repeat step 2 until no more transitions can be added in Tₛ. Then return all transitions in Tₛ. that are enabled in s.

### Algo₁ for Computing Conditional Stubborn Sets

In Algo₁ dependencies between transitions, arising out of operations on shared communication objects are captured using the [symbol] ₛ relation which captures for each operation op used by a transition in a state s which other operations might be first to interfere with op from the current state s. In practice, to avoid exploration of the state space of the program at hand, static analysis is employed in order to compute a relation, [symbol] ₛ^{st}. which is an over-approximation of [symbol] ₛ. Towards that end, we say that two operations op and op′ are statically dependent if they access a common shared variable such that at least one of the accesses is a write operation. Then [symbol] ₛ^{st}, is defined as follows.

Definition: Let op and op′ be two operations on a common shared variable and s is a reachable state of A_{G}. The relation [symbol] ₛ^{st} op′ holds iff there exist distinct threads Tᵢ and Tⱼ such that there exists (1) a transition of Tᵢ scheduled—but not necessarily enabled—at s using op, and (2) a local path

$$x \text{:} {p}_{0} {\to }^{{t}_{1}} … {\to }^{{t}_{1}} {p}_{n}$$

of Tⱼ such that p₀ is the local state of Tⱼ in s, ∀1≦k ≦n: ∀op″ is used by tₖ: op and op″ are not statically dependent, tₙ uses op′, and op and op′ are statically dependent.

To incorporate on-the-fly transactions, we modify the above definition of [symbol] ₛ^{st} to obtain a new relation [symbol] ₛ^{lp}⊂ [symbol] ₛ^{st} by adding (in accordance with our discussion above), the extra constraint that none of the locks held by Tᵢ in x is acquired (and possibly released) by Tⱼ along x. Note that since [symbol] ₛ^{tp} is more constrained it enforces fewer dependencies between operations than [symbol] ₛ^{st} thus resulting in smaller conditional stubborn sets. As a result, certain interleavings are “weeded out” to produce the effect of executing transactions.

Indeed—in the example given in FIG. 2—in global state s, if op and op′ are the operations x=0 and x=1 at locations 6a and 6b, respectively, then op [symbol] ₛ^{st} op′ but [symbol] (op [symbol] ₛ^{lp} op′). Thus, using [symbol] ₛ^{lp} instead of [symbol] ₛ^{st} to compute conditional stubborn sets removes transition 1b from the conditional stubborn set s of thereby preventing a context switch before 6a.

Formally, [symbol] ₛ^{lp} is defined as follows.

Definition (might-be-the-first-to-interfere-modulo-lock-acquisition) Let op and op′ be two operations on a common shared variable and s a reachable state of A_{G}. The relation op [symbol] ₛ^{lp} op′ holds iff there exist distinct threads Tᵢ and Tⱼ such that there exist: (1) a transition of Tᵢ scheduled (although not necessarily enabled) at s using op and (2) a local path

$$x \text{:} {p}_{0} {\to }^{{t}_{1}} … {\to }^{{t}_{n}} {p}_{n}$$

of Tⱼ such that ∀1≦k<n : ∀op″ used b)y tₖ: op and op′ are not statically, dependent, tₙ uses op′, and op and op′ are statically dependent and no lock held b Tᵢ in s is acquired by Tⱼ along x.

Now, if we let Algo₂ be the result of replacing [symbol] ₛ in Algo₁ by [symbol] ₛ^{st} and Algo₃ the result of replacing [symbol] ₛ^{st} in line 2. (b) .i of Algo₂ by [symbol] ₛ^{lp}. Then the following two results state that Algo₃ does advantageously compute a conditional stubborn set than is smaller than one computed by Algo₂. Note however, that although we used a specific relation [symbol] ₛ^{st} for computing dependencies statically, one can of course incorporate on-the-fly transactions with any other implementation of [symbol] ₛ by merely adding the extra condition regarding lock acquisition patterns, as above.

Theorem 1. All sets Tₛ that are computed by Algo₃ are conditional stubborn sets of s.

Proof Sketch: Let

$$t = a {\to }^{g} b$$

executed by thread Tⱼ belong to Tₛ. Let

$$w = {s}_{1} {\to }^{{t}_{1}} {s}_{2} {\to }^{{t}_{2}} … {\to }^{{t}_{n}} {s}_{n + 1}$$

be a sequence of transitions of A_{G} such that t is dependent with tₙ in sₙ. We need to show that at least one of t₁, . . . , tₙ is in Tₛ. Without loss of generality, we may assume that for 1≦i<n,t is independent with tᵢ, in sᵢ and tₙ is dependent with t in sₙ, else we can pick an appropriate prefix of w.

First, we assume that t is disabled in s. Since t is disabled in s, and sₙ is the first state along w in which t is dependent (with tₙ), we have that t is enabled in sₙ₊₁. Since t is disabled in s, either s[i]≠a, or a condition c in guard g evaluates to false in s. In the first case, since t is enabled in Sₙ₊₁, there exists a transition tⱼ fired along w, of the form d→a labeled with some guard g′. But then executing step 2. (a) .i of Algo₃ would cause tⱼ to be included in Tₛ.

In the second case, there exists a transition tⱼ that changes the value of c from false to true by changing the output of an operation op used to evaluate c, i.e., by performing an operation op′ dependent with op in s_{j l Let t}ⱼ be the first such transition occurring along w. Clearly, op′ is statically dependent with op. By definition of [symbol] ₛ^{st}, we have op [symbol] ₛ^{st} op′, and so tⱼεTₛ by step 2. a. (ii).

We may now consider the case where t is enabled in s. From the facts that: (i) for 1≦j ≦n−1, t is independent with tⱼ in sⱼ,and (ii) t is enabled in s, we have that for 1≦j ≦n−1, t is enabled in sⱼ. This implies that the thread Tᵢ does not execute any transition along w, otherwise—since Tᵢ is deterministic—we conclude that t is the first transition that Tᵢ executes along w.

As can be appreciated, this would force Tᵢ out of its current local state thereby disabling t and thereby contradicting the above observation. Note that here we assumed that executing a transition takes a process out of its current local state, i.e., there are no self loops in a program thread—which is a reasonable assumption for software programs.

Now, since t and tₙ are dependent in sₙ, it implies that ∃opεused(t),∃op′ εused(tₙ):op and op′ are dependent in sₙ and therefore are also statically dependent. If we let tⱼ be the first transition along w that uses an operation op″ dependent op. Note also that there does not exist a lock 1 held by Tᵢ at s such that 1 has to be acquired before tⱼ is executed along w. Otherwise, 1 must first be released by Tᵢ thus forcing Tᵢ to execute a transition contradicting our observation made above that Tᵢ does not execute any transition along w Thus we have op [symbol] ₛ^{lp} op″ and hence tⱼε Tₛ by step 2.b. (i).

Theorem 2. For all transitions t that are enabled in s, for all persistent sets Algo₂ that can be returned by Algo₂, there exists a run of Algo₃ that returns a persistent set Algo₃(t)⊂Algo₂.

Proof Sketch: From the definition of relation [symbol] ₛ^{lp}, it follows that [symbol] ₛ^{lp} is included in [symbol] ₛ^{st}. Thus the set Tₛ returned by Algo₃ is always a subset of the one returned by Algo₂ provided the same choices are made in case of nondetermination.

Software Modeling for Concurrent C Programs

Translating Individual Threads Into Circuits

We may now describe how—using F-Soft—we first obtain a circuit-based model of each thread, under the assumption of bounded data and bounded control (recursion) (See, e.g., F. Ivancic et. al. “Model Checking C Programs Using F-Soft”, In ICCD, 2005). Briefly, we begin with a C program and apply a series of source-to-source transformations to simplify complex C expressionism into smaller but equivalent subsets of C. Next, all arrays and structs are “flattened” by replacing them with collections of simple scalar variables, aid then build ant internal memory representation of the program by assigning to each scalar variable a unique number representing its memory address.

Variables that are adjacent in C program memory are given consecutive memory addresses in our model; which advantageously facilitates modeling of pointer arithmetic The heap is modeled as a finite array, by adding a simple implementation of malloc ( ) that returns pointers into this array.

For handling pointer accesses we first perform a “points-to” analysis to determine the set of variables that a pointer variable can point to. Then, we convert each indirect memory access, through a pointer or an array reference, to a direct memory access. For example, if we determine that pointer p can point to variables a, b, . . . , z at a given program location: we rewrite a pointer read *(p+i) as a conditional expression of the form:
((p+i)==&a ? a:((p+i)==&b ? b: . . . )),
where &a,&b, . . . are the numeric memory addresses we assigned to the variables a, b, . . . , respectively.

Nonrecursive function calls are handled by inlining exactly once, and replacing that particular function's return by a set of goto-s conditioned upon the unique call site id stored on that function's entry. Bounded recursive functions are modeled by introducing a bounded call stack. While we aim for accurate modeling of all C, practical modeling requires making approximations.

Accordingly, large arrays are truncated. Writes to elements above a certain index are ignored, and reads from these elements yield non-deterministic values. Floating-point values are approximated by modeling their integral parts only The simplified program includes scalar variables of simple types (Boolean, enumerated, integer). This is compiled using standard techniques into its control flow graph (CFG). T

Those skilled in the art will recognize that the CFG representation can be viewed as a finite state machine with state vector (pc, V), where pc denotes an encoding of the basic blocks, and V is a vector of integer-valued program variables. We then construct symbolic transition relations for pc, and for each data variable appearing in the program. For pC, the transition relation reflects the guarded transitions between basic blocks in the CFG counter. For a data variable, the transition relation is built from expressions assigned to the variable in various blocks. Finally, we construct a symbolic representation of these transition relations resembling a hardware circuit. For the pc variable, we allocate ┐log N┌ latches, where N is the total number of basic blocks. For each C program variable, we allocate a vector of n latches, where n is the bit width of the variable. Al the end, we obtain a circuit-based model of each thread of the given concurrent program, where each variable of the thread is represented in terms of a vector of binary-valued latches and a Boolean next-state function (or relation) for each latch.

Building The Circuit for the Concurrent Program

Given the circuit Cᵢ for each individual thread Tᵢ, we may now show how to get the circuit C for the concurrent program CP comprised of these threads. In the case where local variables with the same name occur in multiple threads, to ensure consistency we prefix the name of each local variable of thread Tᵢ with thread i. Next, for each thread we introduce a gate execute_i indicating whether Pᵢ has been scheduled to execute in the next step of CP or not.

For each latch l, we let next-statesᵢ(l) denote the next state function of l in circuit Cᵢ. Then in circuit C, the next state value of latch thread_i_l corresponding to a local variable of thread Tᵢ, is defined to be next-stateᵢ(thread_i_l) if execute_i is true, and the current value of thread_i_l, otherwise. If, on the other hand, latch l corresponds to a shared variable, then next-state(l) is defined to be next-stateᵢ(l), where execute_i is true. Note that we need to ensure that execute_i is true for exactly one thread T₁. Towards that end, we implement a scheduler which determines in each global state of CP which one of the signals execute_i is set, to true and thus determines the semantics of thread composition.

Conditional Stubborn Sets Based Persistent Sets

To incorporate partial order reduction, we need to ensure that from each global state s only transitions belonging to a conditional stubborn set of s are explored. We let R and Rᵢ denote the transitions relations of CP and T₁, respectively. If CP has n threads, we introduce the n-bit vector cstub which identities a conditional stubborn set for each global state s, i.e., in s,cstubᵢ is true for exactly those threads Tᵢ such that the (unique) transition of Tᵢ—enabled at s—belongs to the same minimal conditional stubborn set of s. Then:

$$R ( s , {s}^{′} ) = {⩔}_{1 \leq i \leq n} ( ( execute\_i ) ⩓ {cstub}_{i} ( s ) ⩓ {R}_{i} ( s , {s}^{′} ) ) .$$

The cstub vector may be computed as follows:
1 For each shared variable x and thread Tᵢ, we introduce a latch touch-now(Tᵢ,x) which is true at control location pcᵢ of Tᵢ iff Tᵢ accesses x at control location pcᵢ. This can be done via static analysis of the CFG of Tᵢ by determining at which control locations x was accessed and taking a disjunction for those values of pcᵢ.
2. For each shared variable x, and thread Tᵢ, introduce the latch touch-now-later(Tᵢ,x), which is true at control location pcᵢ. Thus, computing touch-now-later (Tᵢ,x) involves deciding the reachability of pc′ⱼ, and since it cannot be computed exactly without exploring the entire state space A_{G} of CP, we over-approximate it by performing a context-sensitive analysis of the control-flow graph of Tⱼ. We set touch-now-later-pair (Tⱼ,x)to true in control pcⱼ if for some control pc′ⱼ in the control flow graph of Tⱼ,x is accessed at pc′ⱼ.
3 For distinct threads Tᵢ and Tⱼ the relation conflictᵢ(j) is then defined as [symbol] _{xεv}_{ₛₕ}(touch−now(Tᵢ,x)(pcᵢ) [symbol] touch−now−later(Tⱼ,x)(pcⱼ)), where pcᵢ and pcⱼ are the control locations of Tᵢ and Tⱼ, respectively, in the current global state and Vₛₕ is the set of shared variables of CP.
4. Using a circuit to compute transitive closures, for each i, starting with Jᵢ={i} we compute the closure of Jᵢ under the conflict relation defined above.
5 We build a circuit to compute the index in such that the cardinality of Jₘᵢₙ is the least among the sets J₁, . . . , Jₙ. Finally ∀1≦i≦n, set cstubᵢ=1 iff iεJₘᵢₙ. Note that in the implementation we need to pick only one set with the least cardinality.

Cycle Detection: We first identify sticky transitions for all potential global cycles. We then force a conflict for the process containing the sticky locations with all other processes via the encoding below.

More particularly, we let sticky(pc) be a predicate evaluating to true iff location pc has been marked sticky. Then, for global state s, we define
conflictᵢ(j)=sticky (pcᵢ) [symbol] (touch−now(Tᵢ,x)(pcᵢ) [symbol] touch−now−later (Tⱼ,x)(pcⱼ))
where PCₘ is tile current control location of Tₘ in s. In other words, if pcᵢ is sticky then thread Tᵢ is said to conflict with all other threads. This implies that either a thread Tₖ−with smaller conflict set Jₖ—would be chosen for the persistent set computation or a full expansion would be forced.

Those skilled in the art will now recognize that this reduction is sound, since any cycle in the global state space can be projected on to one or more local cycles in the control flow graph of the individual threads. By forcing a full expansion inside each (potential) local cycle with the help of sticky transitions, we advantageously ensure that there is no global cycle such that a thread transition is postponed at each state of the cycle. Therefore this encoding allows the model checker to explore a conservative over-approximation of the representative (minimal) set of interleavings of the given threads. Although the reduced model remains sound, the number of interleavings considered may decrease dramatically with the number of annotated sticky transitions.

Encoding Lock Pattern Based Reduction

In order to incorporate transactions on-the-fly, we advantageously have augmented the predicate touch-now-later, to generate the new predicate touch-know-later-LS that also includes lock acquisition pattern information. For control locations pcᵢ and pc′ᵢ of thread Tᵢ, we let paths (pcᵢ, pc′ᵢ) denote the set of paths in the CFG of Tᵢ starting from pcᵢ that may reach pc′ᵢ. For each π ε paths (pcᵢ, pc′ᵢ) of Tᵢ, let lockPred(π) be a formula denoting the set of locks acquired (and possibly released) among π, e.g., lk₁=T₁ [symbol] lk₂=Tᵢ.

Let touch−now−later−pair(Tⱼ,x)(pc′) [symbol] APₓ(pcⱼ,cp′ⱼ), where APₓ(pcᵢ,pc′ᵢ)= [symbol] _{πεpaths(pc}_{ᵢ}_{,pc′}_{ᵢ}) lockPred(π). Let CLP(Tᵢ,s) denote a formula encoding the ownership of locks Tᵢ in global state s. Then the relation touch−now−LS(Tᵢ,x) is obtained from touch−now−later−pair(Tᵢ,x) by quantifying out pc′ᵢ in conjunction with the CLP(Tᵢ,s),i.e., touch−now−LS(Tᵢ,x)(pcᵢ)=(∃pc′ᵢtouch−now−later−pair(Tᵢ,x)(pcᵢ, pc′ᵢ)) [symbol] CLP(Tᵢ,s)

Therefore, touch−now−LS(Tᵢ,x)(pcᵢ) is true if there is a location pc′ᵢ accessing a shared variable x that is reachable from pcᵢ via a local path π in Tᵢ such that no lock held in s is acquired along π. We evaluate lockPred (π) using a context sensitive static analysis of the CFG of Tᵢ.

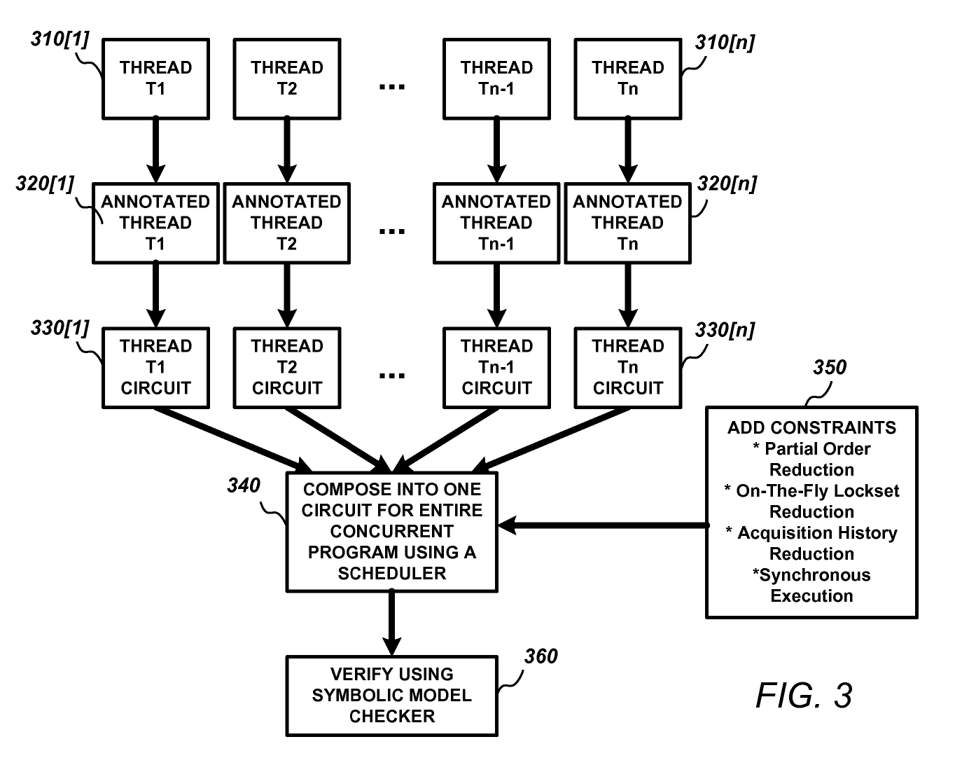

With the theoretical basis in place we may now summarize our inventive method which is shown in a block diagram in FIG. 3. In particular, and with reference to that figure, a number of individual threads 310[1] . . . 310[n] which comprise a concurrent multi-threaded program are reduced into a like number of reduced threads 320[1] . . . 320[n] through a static analysis including a number of a variety of known methods including slicing, range analysis and constant folding. These reduced threads are further translated into a circuit-based (finate state) model 330[1] . . . 330[n] for each individual thread respectively where each variable of the thread is represented in terms fo a vector of binary-valued latches and a Boolean next-state function (or relation) for each latch.

The individual circuits 330[1] . . . 330[n] are combined by a scheduler into a single circuit for the entire concurrent program to which constraints are added 350 for partial order reduction, on-the-fly lockset reduction, acquisition history reduction and/or synchronous execution and constraints are added. Finally, the circuit is verified using symbolic model checking 360.

The Daisy Case Study

We have employed our method of the present invention to find bugs in the Daisy file system which those skilled in the art will recognize as a benchmark for analyzing the efficacy of different concurrent program verification methodologies for verifying concurrent programs. Daisy is a Java implementation of a toy file system where each file is allocated a unique inode that stores the file parameters and a unique block which stores data. One interesting feature of Daisy is that it has fine grained locking in that access to each file, inode or block is guarded by a dedicated lock. Moreover, the acquire and release of each of these locks is guarded by a ‘token’ lock. Conseqently control locations in the program might possibly have multiple open locks and furthermore the acquire and release of a given lock can occur in different procedures.

Currently F-Soft only accepts programs written in C se we first manually translate the Daisy code which is written in Java into C. Furthermore, to reduce the model sizes, we truncated the sizes of the data structures modeling the disk, inodes, blocks, file names. etc., which were not relevant to the race conditions we checked, resulting in a sound and complete small-domain reduction. We have shown the existence of the race conditions described below and noted in the art.

The efficacy of our techniques can be evaluated from the fact that our model checking methodology according to the present invention is able to detect these race conditions in Daisy in a fully automatic fashion directly on the source code without any code structuring/abstractions beyond redefining the constants as discussed above.

Daisy maintains an allocation area where for each block in the file system a bit is assigned 0 or 1 accordingly as the block has been allocated to a file or not. But each disk operation reads/writes an entire byte. Two threads accessing two different files might access two different blocks. However since bytes are not guarded by locks in order to set their allocation bits these two different threads may access the same byte in the allocation block containing the allocation bit for each of these locks thus setting up a race condition.

The verification statistics we observed are as follows: We ran our experiments on a machine with an Intel Pentium4 3.20 GHz processor and 2 GB RAM. Each run was given a timeout of 2 days and had a memout of 2 GB. Witnesses for the above race condition were found in two cases, those corresponding to blocks 0 and 1, and those due to blocks 1 and 2. In sharp contrast, when using purely interleaved scheduling, we failed to find either witness because of a “memout” at depth 15.

When only partial order reduction was employed, was found using SAT-based BMC at unroll depth 122 in 36707 sec and 999 MB while incorporating on-the-fly transactions drastically reduced the time and memory usage to 1283 sec and 122 MB respectively The second witness was found at depth 151. Using partial order reduction techniques alone took 145176 sec and 1870 MB, while adding transactions reduced ii to 5925 see and 902 MB.

In Daisy reading/writing a particular byte on the disk is broken down into two operations: a seek operation that mimics the positioning of the head and a read/write operation that transfers the actual data. Due to this separation between seeking and data transfer a race condition may occur. For example, reading two disk locations, say n and m, we must make sure that seek(n) is followed by read(n) without seen(n) or read(n) scheduled in between. In this case a witness was found at depth 48. Using partial order reduction alone took 2.99 see and 5.7 MB while adding transactions reduced it to 2.89 sec and 5.5 MB. For this example also BMC on the completely interleaved model failed to find a witness because of a memout at depth 20

Advantageously, and as can be readily appreciated by those skilled in the art—for deep bugs techniques that leverage the use of on-the-fly transactions combined with partial order reduction greatly outperform those which use only partial order reduction—both in terms of time taken and memory used.

At this point, while we have discussed and described our invention using some specific examples, those skilled in the art will recognize that my teachings are not so limited. Accordingly, our invention should be only limited by the scope of the claims attached hereto.

What is claimed is:

1. A computer implemented method for analyzing a concurrent program comprising the steps of:
generating a model of the concurrent program; and
verifying the concurrent program through the use of a symbolic model checker;
THE METHOD CHARACTERIZED IN THAT
the model is reduced through the application of a lock acquisition history analysis.

2. The method claim 1 further CHARACTERIZED IN THAT:
the acquisition history analysis reduces the number of stubborn sets.

3. The method of claim 2, further CHARACTERIZED IN THAT:
the concurrent program need not exhibit any substantial lock discipline.

4. The method of claim 3 further CHARACTERIZED IN THAT:
a set of transactions are determined based upon the lock acquisition history analysis and information about the determined transactions are used to further reduce the number of stubborn sets.

5. The method of claim 4 wherein any constraints of the stubborn sets are represented symbolically.

6. The method of claim 5 wherein the model of the concurrent program is represented symbolically in circuit-form.

7. A computer implemented method for analyzing a concurrent program comprising a number of individual threads, said method comprising the steps of:
generating a model of the concurrent program; and
verifying the concurrent program through the use of a symbolic model checker;
THE METHOD CHARACTERIZED IN THAT
the model is reduced through the application of a lock acquisition history analysis wherein said lock acquisition history analysis is performed on a per-thread basis.

8. The method claim 7 further CHARACTERIZED IN THAT:
the acquisition history analysis reduces the number of stubborn sets.

9. The method of claim 8 further CHARACTERIZED IN THAT:
the concurrent program need not exhibit any substantial lock discipline.

10. The method of claim 9 further CHARACTERIZED IN THAT:
a set of transactions are determined based upon the lock acquisition history analysis and information about the determined transactions are used to further reduce the number of stubborn sets.

11. The method of claim 10 wherein any constraints of the stubborn sets are represented symbolically.

12. The method of claim 11 wherein the model of the concurrent program is represented symbolically in circuit-form.
